(19) United States
(12) Patent Application Publication
(10) Pub. No.: US 2026/0319194 A1
(43) Pub. Date: Oct. 15, 2026

(54) DETACHABLE OPTICAL COUPLING ASSEMBLY

(71) Applicant: AIP Inc., New Taipei City (TW)

(72) Inventor: Chia Lee, New Taipei City (TW)

(21) Appl. No.: 19/645,191

(22) Filed: Apr. 12, 2026

Related U.S. Application Data
(63) Continuation-in-part of application No. 18/510,668, filed on Nov. 16, 2023, now Pat. No. 12,656,561.
(63) Continuation-in-part of application No. 19/259,403, filed on Jul. 3, 2025.
(60) Provisional application No. 63/528,933, filed on Jul. 26, 2023.
(60) Provisional application No. 63/781,378, filed on Apr. 1, 2025.
(60) Provisional application No. 63/907,326, filed on Oct. 29, 2025.

(51) Int. Cl. G02B 6/42

(52) U.S. Cl. CPC G02B 6/4214

(57) ABSTRACT

A detachable optical coupling assembly is provided. The detachable optical coupling assembly includes a first connector and an optical fiber device. The first connector is disposed on a photonic integrated circuit and includes a waveguide device and a base including a front end. The waveguide device includes a waveguide substrate with a first guide surface, a plurality of optical waveguide paths extending from the first guide surface and a surface grating coupler formed on the waveguide substrate. The waveguide device is disposed in the base such that the first guide surface is positioned at the front end. The surface grating coupler is optically coupled to a signal transmission portion of the photonic integrated circuit. The optical fiber device includes a second connector detachably connected to the first connector such that a connecting surface of the second connector and the first guide surface are disposed to face each other.

### CROSS REFERENCE TO RELATED APPLICATIONS

This application is a continuation-in-part of U.S. patent application Ser. No. 18/510,668, filed on Nov. 16, 2023, and claims the benefit of U.S. Provisional Patent Application No. 63/528,933, filed on Jul. 26, 2023; U.S. Provisional Patent Application No. 63/781,378, filed on Apr. 1, 2025; U.S. patent application Ser. No. 19/259,403, filed on Jul. 3, 2025; and U.S. Provisional Patent Application No. 63/907,326, filed on Oct. 29, 2025, the entire contents of each of which are incorporated by reference herein.

### FIELD OF DISCLOSURE

The present application relates to optoelectronic integrated circuits (OEICs), and more particularly to a detachable optical coupling assembly.

### BACKGROUND

Optoelectronic integrated circuits (OEICs) are designed to combine optical and electronic functionalities within a unified system to perform signal processing and communication. By employing photons as a medium for data transmission, OEIC-based systems can provide enhanced bandwidth, reduced signal delay, and improved power efficiency when compared to purely electrical signal paths.

In conventional implementations, an OEIC includes a photonic integrated circuit (PIC) and an electronic integrated circuit (EIC), and such an arrangement is often realized in a co-packaged optics (CPO) form. Optical communication between the OEIC and external devices is commonly performed through optical transmission components, including optical fibers and/or optical waveguides connected to the PICs. To ensure effective optical coupling, conventional approaches rely on bonding techniques in which optical coupling elements, such as lenses or diffractive structures, are secured to the optical fibers and maintained in permanent alignment with the PIC to ensure alignment accuracy and coupling stability. However, such bonded structures must withstand subsequent packaging processes, such as reflow or other back-end manufacturing steps performed at temperatures exceeding approximately 220 °C, thereby subjecting the optical fibers and associated components to elevated thermal stress and potential thermal damage.

In addition, when optical transmission components such as optical fibers or optical waveguides are permanently attached to the PIC, replacement or reconfiguration becomes impractical.

### SUMMARY OF DISCLOSURE

The present application provides a detachable optical coupling assembly.

The detachable optical coupling assembly is configured to be aligned with and securely connected to a photonic integrated circuit (including a single photonic integrated circuit or a photonic integrated circuit of an optoelectronic integrated circuit), thereby enabling a detachable connection between optical fibers and the photonic integrated circuit. Through the structural configuration of the connectors of the detachable optical coupling assembly, a waveguide device is optically coupled to a signal transmission portion of the photonic integrated circuit, thereby improving optical alignment accuracy. In addition, surface grating couplers formed on the waveguide device or the photonic integrated circuit enlarges the effective coupling area and enhances overall optical coupling efficiency.

In a first aspect, the present application provides a detachable optical coupling assembly. The detachable optical coupling assembly includes a first connector and an optical fiber device. The first connector is disposed on a photonic integrated circuit and includes a base and a waveguide device. The base includes a front end. The waveguide device includes a waveguide substrate with a first guide surface, a plurality of optical waveguide paths extending from the first guide surface, and a surface grating coupler formed on the waveguide substrate. The waveguide device is disposed in the base such that the first guide surface is positioned at the front end. The surface grating coupler of the waveguide device is optically coupled to a signal transmission portion of the photonic integrated circuit.

The optical fiber device includes a second connector with a connecting surface and is detachably connected to the first connector such that the connecting surface and the first guide surface are disposed to face each other.

Optionally, in some embodiments of the present application, the photonic integrated circuit further includes a surface grating coupler formed within the signal transmission portion, and the surface grating coupler of the waveguide device is optically coupled to the surface grating coupler of the photonic integrated circuit.

Optionally, in some embodiments of the present application, the base further includes a lower surface and at least one retaining wall extending downward from the lower surface, and the retaining wall abuts against an edge of the photonic integrated circuit.

Optionally, in some embodiments of the present application, the base further includes an upper surface and a recessed portion recessed relative to the upper surface, and the waveguide device is disposed at the recessed portion.

Optionally, in some embodiments of the present application, the first connector further includes a plurality of positioning elements disposed at the front end. The second connector further includes a plurality of attaching portions detachably connected to the plurality of positioning elements.

Optionally, in some embodiments of the present application, the optical fiber device further includes a plurality of optical fibers extending to the connecting surface and arranged in correspondence with the plurality of optical waveguide paths.

In a second aspect, the present application further provides a detachable optical coupling assembly.

The detachable optical coupling assembly includes a first connector, a photonic integrated circuit and an optical fiber device. The first connector includes a base including a front end. The photonic integrated circuit includes a main body and a waveguide device. The waveguide device includes a waveguide substrate, a plurality of optical waveguide paths, and a plurality of surface grating couplers. The waveguide substrate is integrated with the main body and includes a first guide surface. The plurality of optical waveguide paths extend from the first guide surface. The plurality of surface grating couplers are disposed at respective ends of the plurality of optical waveguide paths near the first guide surface. The waveguide device is disposed in the base such that the first guide surface is positioned at the front end. The optical fiber device includes a second connector with a connecting surface and a plurality of optical fibers. The second connector is detachably connected to the first connector such that the connecting surface and the first guide surface are disposed to face each other. The plurality of optical fibers extend from the connecting surface and are arranged in correspondence with the plurality of surface grating couplers of the waveguide device, respectively.

Optionally, in some embodiments of the present application, the base further includes a lower surface and at least one retaining wall extending downward from the lower surface, and the retaining wall abuts against an edge of the photonic integrated circuit.

Optionally, in some embodiments of the present application, the base further includes an upper surface and a recessed portion recessed relative to the upper surface, and the waveguide device is disposed at the recessed portion.

Optionally, in some embodiments of the present application, the first connector further includes a plurality of positioning elements disposed at the front end, and the second connector further comprises a plurality of attaching portions detachably connected to the plurality of positioning elements.

Optionally, in some embodiments of the present application, the photonic integrated circuit further includes a signal transmission portion connected to the plurality of optical waveguide paths.

Optionally, in some embodiments of the present application, each of the plurality of surface grating couplers is a side-coupling grating coupler.

Optionally, in some embodiments of the present application, the first guide surface is an upper surface of the waveguide substrate. An extension direction of the plurality of optical fibers disposed near the connecting surface forms an acute angle with the upper surface.

Optionally, in some embodiments of the present application, each of the plurality of surface grating couplers is a side-coupling grating coupler.

The present application offers the following beneficial effects:

The detachable optical coupling assembly enables a detachable connection between the optical fiber device and the photonic integrated circuit via the first connector, therefore the photonic integrated circuit can be co-packaged with a carrier board and subjected to subsequent packaging or assembly processes without exposing the optical fiber device to high-temperature environments. As a result, potential thermal damage to the optical fiber device is avoided. manufacturing yield is improved, and replacement or maintenance of the optical fiber device can be performed more conveniently.

In addition, through the structural arrangement of the first connector, the waveguide device can be actively aligned with the signal transmission portion of the photonic integrated circuit, thereby maintaining alignment accuracy during optical coupling.

Furthermore, the surface grating coupler of the waveguide device are optically coupled with the surface grating coupler disposed at the signal transmission portion of the photonic integrated circuit, such that light beams transmitted from the optical fiber device are coupled into the waveguide device, guided toward the signal transmission portion, and subsequently propagated along the extension direction of the signal transmission portion into the photonic integrated circuit. Through the cooperative arrangement of the surface grating coupler, the effective optical coupling area is increased, alignment tolerance is enhanced, bidirectional transmission of light signals is stabilized, and overall optical coupling efficiency of the optoelectronic integrated circuit is improved.

### BRIEF DESCRIPTION OF DRAWINGS

The accompanying drawings briefly illustrate various embodiments of the present application and are provided to facilitate understanding of the disclosed technical solutions. These drawings depict only example embodiments and do not limit the scope of the present application.

FIG. 1 is a perspective view of a detachable optical coupling assembly according to some embodiments of the present application.

FIG. 2 is an exploded view of the detachable optical coupling assembly according to some embodiments of the present application.

FIG. 3 is a perspective view of the detachable optical coupling assembly, showing an optical fiber device and a first connector of the detachable optical coupling assembly in an attached state, according to some embodiments of the present application.

FIG. 4 is a perspective view of a waveguide device of the detachable optical coupling assembly according to some embodiments of the present application.

FIG. 5 is a perspective view of the detachable optical coupling assembly connected to a photonic integrated circuit according to some embodiments of the present application.

FIG. 6 is a perspective view of the photonic integrated circuit shown in FIG. 5.

FIG. 7 is a perspective view of the first connector connected to the photonic integrated circuit shown in FIG. 5 without the optical fiber device attached.

FIG. 8 is a top plan view of the first connector and the photonic integrated circuit shown in FIG. 7.

FIG. 9 is a schematic cross-sectional view of the first connector and the photonic integrated circuit, taken along line A-A of FIG. 8, according to some embodiments of the present application.

FIG. 10 is a schematic cross-sectional view of the first connector and the photonic integrated circuit according to other embodiments of the present application.

FIG. 11 is a top plan view of the first connector and the photonic integrated circuit co-packaged with a carrier board according to some embodiments of the present application.

FIG. 12 is a perspective view of a detachable optical coupling assembly including a photonic integrated circuit according to some embodiments of the present application.

FIG. 13 is a perspective view of the detachable optical coupling assembly showing an optical fiber device and a first connector of the detachable optical coupling assembly in an attached state according to some embodiments of the present application.

FIG. 14 is a perspective view of a waveguide device and the photonic integrated circuit according to some embodiments of the present application.

FIG. 15A is a perspective view of the first connector and the photonic integrated circuit in a detached state according to some embodiments of the present application.

FIG. 15B is a perspective view of the first connector and the photonic integrated circuit in an attached state according to some embodiments of the present application.

FIG. 16 is a schematic cross-sectional view taken along line B-B of FIG. 13.

FIG. 17 is a top plan view of the first connector and the photonic integrated circuit shown in FIG. 12.

FIG. 18 is a schematic cross-sectional view taken along line C-C of FIG. 17.

FIG. 19 is a schematic cross-sectional view of the first connector and the photonic integrated circuit according to other embodiments of the present application.

### DETAILED DESCRIPTION

The following embodiments are provided with reference to the accompanying drawings to illustrate specific implementable examples of the present application. These descriptions are provided for illustration purposes only and are not intended to limit the scope of the present application. These embodiments may be implemented in various forms and are not intended to limit the present application. The technical features of the various embodiments described herein may be combined with one another, provided that such combinations are implementable by a person of ordinary skill in the art.

The terms such as “first” and “second,” as used herein, are intended solely for purposes of description and should not be construed as indicating or implying relative importance, order, or an implied number of the referenced features. Accordingly, features designated as “first” or “second” may explicitly or implicitly include one or more such features. Directional or positional terms such as “upper,” “lower,” “front,” and similar terms, as used herein, are intended solely to describe relative positions or orientations of components for convenience of explanation and should not be construed as limiting the actual structure, orientation, or configuration of the present application.

The present application provides a detachable optical coupling assembly according to some embodiments of the present application.

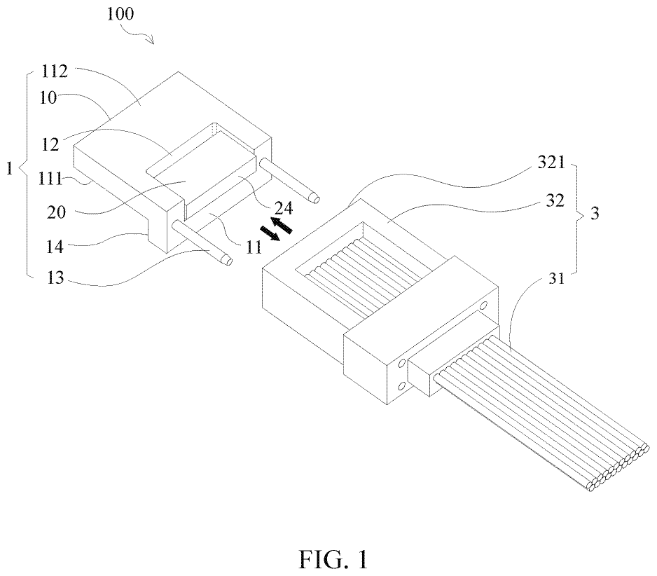

Referring to FIGS. 1, 2 and 5, the detachable optical coupling assembly 100 includes a first connector 1 and an optical fiber device 3. The first connector 1 is disposed on a photonic integrated circuit 51 and includes a base 10 and a waveguide device 20. The base 10 includes a lower surface 111, an upper surface 112, a front end 11, and a recessed portion 12. The front end 11 is disposed between corresponding edges of the lower surface 111 and the upper surface 112. The recessed portion 12 is recessed relative to the upper surface 112 and extends to the front end 11.

In some embodiments, the base 10 is rectangular in shape, and the recessed portion 12 is formed from the front end 11 and is extended through both the lower surface 111 and the upper surface 112 of the base 10, such that the waveguide device 20 is receivable in the recessed portion 12 of the base 10.

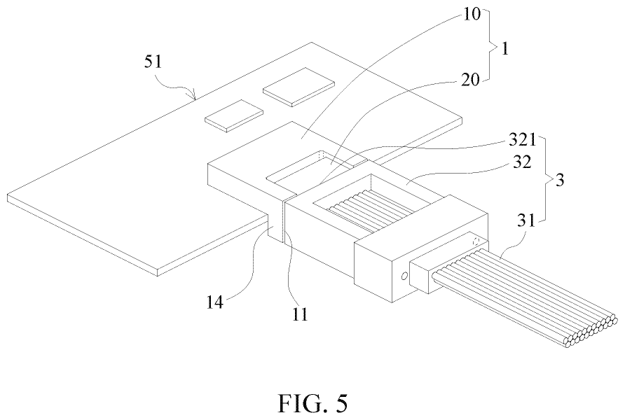

In some embodiments, the first connector 1 further includes at least one retaining wall 14. The retaining wall 14 extends downward from the lower surface 111 and abuts against an edge of the photonic integrated circuit 51 (as shown in FIG. 5) to prevent displacement of the first connector 1. In some embodiments, the base 10 of the first connector 1 includes one retaining wall 14 extended downward in a bent manner to provide the base 10 with an L-shaped cross-sectional profile.

The first connector 1 further includes a plurality of positioning elements 13 disposed on a surface of the front end 11 facing the optical fiber device 3. In some embodiments, the first connector 1 includes two positioning elements 13 spaced apart from each other, and each positioning element 13 is rod-shaped and extending outward from the front end 11 adjacent to the retaining wall 14.

In some embodiments, the base 10 is formed of a high-temperature-resistant material capable of withstanding high-temperature processes (e.g., processing temperature higher than 220 °C), such as ceramic, metal, or polymeric material.

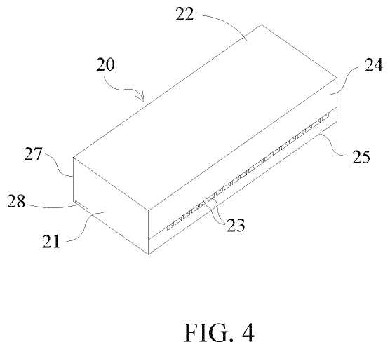

Referring to FIG. 4, the waveguide device 20 includes a waveguide substrate 21, a first surface 22 on an upper side of the waveguide substrate 21, a second surface 25 on a lower side of the waveguide substrate 21, a first guide surface 24 adjoining the first surface 22 and the second surface 25, a plurality of optical waveguide paths 23, and a surface grating coupler 28 formed on surface of the waveguide substrate 21. The waveguide device 20 is disposed in the base 10 such that the first guide surface 24 is positioned at the front end 11.

The optical waveguide paths 23 extend from the first guide surface 24. In some embodiments, the optical waveguide paths 23 are groove-shaped and are formed in the waveguide device 20 between the first surface 22 and the second surface 25 as shown in FIG. 4. In other embodiments, the optical waveguide paths 23 may be provided in an array along the first surface 22 or the second surface 25 and extend toward the first guide surface 24 to propagate light beams, but are not limited thereto. When the optical waveguide paths 23 are located on the second surface 25, the surface grating coupler 28 may be disposed on the same surface as an independent structure, or integrated with the optical waveguide paths 23 so that a portion of the optical waveguide paths 23 serves as the surface grating coupler 28.

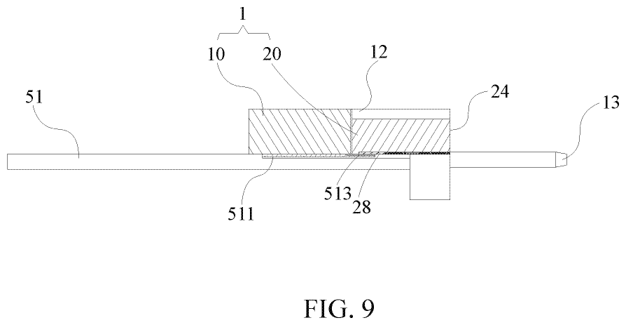

Referring to FIG. 9, the surface grating coupler 28 is optically coupled to a signal transmission portion 511 of the photonic integrated circuit 51 and is configured to couple and direct a propagation direction of light beams, and may be implemented in various patterns such as linear, arcuate, or inclined arrangements depending on the coupling requirements. In some embodiments, as shown in FIGS. 1, 4, 6, and 9, the surface grating coupler 28 is formed on the second surface 25, and the waveguide device 20 is assembled in the recessed portion 12 of the base 10 with the second surface 25 toward the recessed portion 12 such that the surface grating coupler 28 faces the signal transmission portion 511 through the recessed portion 12.

Referring to FIGS. 1 to 3, the optical fiber device 3 is configured for detachable connection to the first connector 1 and includes a plurality of optical fibers 31 and a second connector 32 with a connecting surface 321 and adapted to connect to the first connector 1.

The second connector 32 functions as an optical multi-channel connector and includes a plurality of attaching portions 322. The connecting surface 321 faces the front end 11 of the base 10. When the second connector 32 is detachably connected to the first connector 1, the connecting surface 321 and the first guide surface 24 are disposed to face each other. The attaching portions 322 are formed adjacent to the connecting surface 321 and are detachably connected to and aligned with the positioning elements 13. In some embodiments, two attaching portions 322 are provided, and each attaching portion 322 is hole-shaped to allow insertion of the positioning elements 13.

The optical fibers 31 extend to the connecting surface 321 and are respectively arranged in correspondence with the optical waveguide paths 23 of the waveguide device 20, and each optical fiber 31 terminates at a fiber end 310 at the connecting surface 321 of the second connector 32.

Referring to FIGS. 1 to 4, FIG. 1 and FIG. 3 respectively illustrate the optical fiber device 3 separated from and attached to the first connector 1. In an attached state, the waveguide device 20 is assembled in the recessed portion 12 of the base 10, with the surface grating coupler 28 oriented toward the recessed portion 12. When the positioning elements 13 are inserted into the corresponding attaching portions 322, a snug fit is established between the attaching portions 322 and the positioning elements 13, such that the second connector 32 is detachably and securely connected to the first connector 1. In this configuration, the connecting surface 321 is disposed to face the first guide surface 24, and the fiber ends 310 of the optical fibers 31 are positioned to face the recessed portion 12 and the waveguide device 20 at the front end 11 of the base 10.

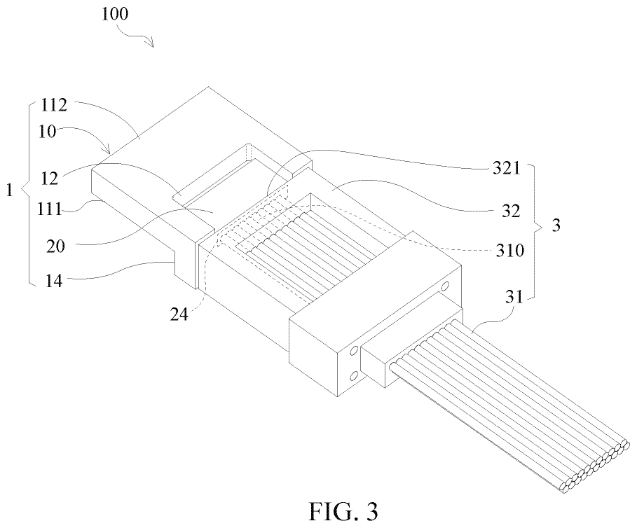

Referring to FIGS. 3 and 4, in some embodiments, to position the waveguide device 20 within the base 10, the base 10 is detachably connected to the optical fiber device 3. The waveguide device 20 is subsequently placed into the recessed portion 12 of the base 10 and is actively aligned with the optical fibers 31 of the optical fiber device 3 by optical monitoring. Alignment is considered achieved when optical signal transmission between the optical fibers 31 and the waveguide device 20 is established. After active alignment, the waveguide device 20 is secured in the recessed portion 12 of the base 10. As shown in FIG. 3, the base 10 and the waveguide device 20 collectively form the first connector 1. After the first connector 1 is prepared, the optical fiber device 3 may be detached from the base 10, as shown in FIG. 1.

Still referring to FIG. 3 and FIG. 4, in some embodiments, the optical fibers 31 are arranged in parallel either in a single row or in multiple rows and extend toward the connecting surface 321, at which fiber ends 310 of the optical fibers 31 are exposed to emit light toward the waveguide device 20. Specifically, when the optical fiber device 3 is attached to the first connector 1 with the waveguide device 20 retained in the recessed portion 12, the first guide surface 24 of the waveguide device 20 and the connecting surface 321 of the second connector 32 are positioned in front of, or coincide with, the fiber ends 310 of the optical fibers 31, thereby enabling optical coupling between the optical fibers 31 and the waveguide device 20. In some embodiments, when multiple waveguide devices 20 are to be positioned in a plurality of bases 10, the above-described configuration is applied repeatedly such that each waveguide device 20 is sequentially disposed in a corresponding base 10, which improves operability, facilitates component replacement, provides greater application flexibility, and enhances assembly efficiency by reducing alignment time.

It should be noted that in some embodiments, no reflective or focusing elements, such as optical lenses, zone plates, or the like, are provided at the fiber ends 310 between the first guide surface 24 and the connecting surface 321. In other embodiments, optical glue may be applied at the fiber ends 310 of the optical fibers 31 between the first guide surface 24 and the connecting surface 321 to reduce refractive index variation. Alternatively, an antireflective coating layer (not shown) may be applied to the fiber ends 310, the first guide surface 24, or both, to prevent signal loss caused by refractive index mismatches at boundaries between the fiber ends 310 and the first guide surface 24. In some embodiments, optical lenses may be provided at the boundaries between the fiber ends 310 and the first guide surface 24 to facilitate optical coupling. In still other embodiments, no intermediate element or substance is provided between the fiber ends 310 and the first guide surface 24, such that the fiber ends 310 are configured to be in direct physical facing the first guide surface 24.

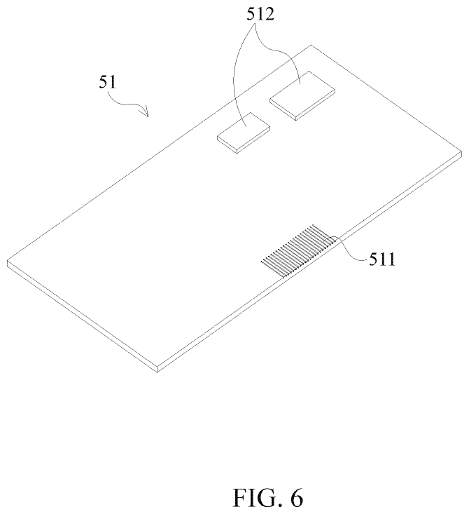

Referring to FIGS. 5 and 6, the photonic integrated circuit 51 includes the signal transmission portion 511 and multiple photonic components 512. The signal transmission portion 511 is configured to establish optical signal transmission with the waveguide device 20 for transmitting light beams from or to the optical fibers 31. The photonic components 512 are configured to form a functional circuit capable of processing optical signals.

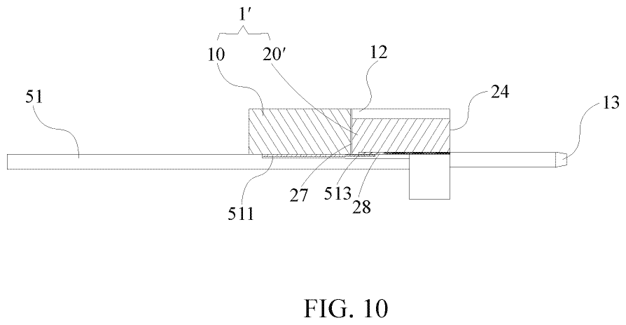

In some embodiments, the photonic integrated circuit 51 further includes a surface grating coupler 513 as shown in FIGS. 9 and 10. The surface grating coupler 513 is formed within the signal transmission portion 511 and is configured to couple and direct a propagation direction of light beams. When the first connector 1 is arranged on the photonic integrated circuit 51, the surface grating coupler 513 of the photonic integrated circuit 51 is optically coupled to the surface grating coupler 28 of the waveguide device 20. The surface grating coupler 513 may be designed in various patterns, such as linear, arcuate, or inclined patterns, according to coupling requirements. It should be noted that the profiles of the signal transmission portion 511 and the surface grating coupler 513 illustrated in the drawings are schematic only and are not limiting, and the size, shape, or layout thereof may be varied depending on the actual design of the photonic integrated circuit 51.

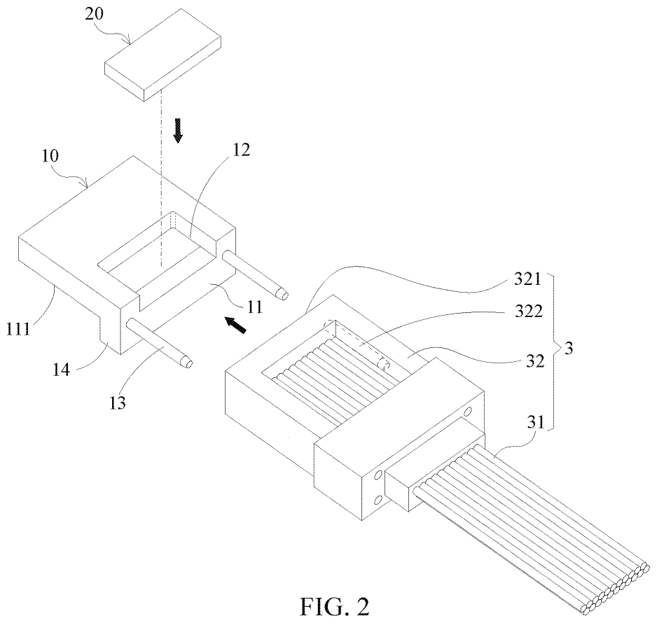

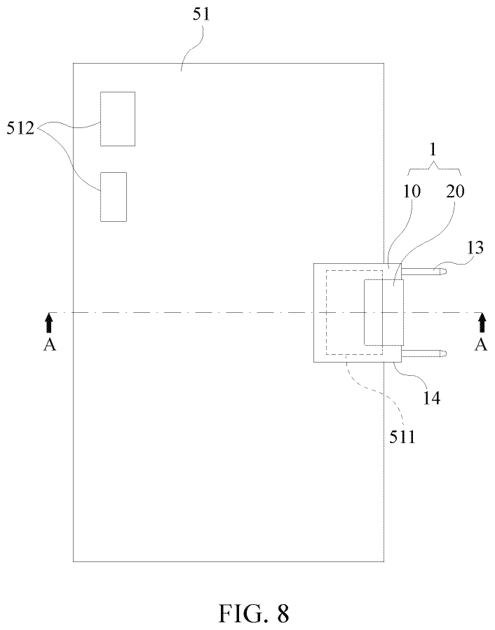

In some embodiments, the optical waveguide paths 23 of the waveguide device 20 as shown in FIG. 4 are arranged in an array and spatially correspond to the signal transmission portion 511 of the photonic integrated circuit 51 as shown in FIG. 6. In such embodiments, referring to FIGS. 2, 8, and 9, the surface grating coupler 513 functions as an interface for efficient in-plane optical coupling with the surface grating coupler 28 of the waveguide device 20 positioned in the recessed portion 12, thereby improving alignment tolerance with the waveguide device 20 and enhancing overall coupling efficiency of the photonic integrated circuit 51.

Referring to FIGS. 5 to 9, to position the first connector 1 on the photonic integrated circuit 51, the first connector 1 is detachably connected to the optical fiber device 3 and actively aligned with the signal transmission portion 511 by optical monitoring, such that light signals are transmitted between the optical fiber device 3 and the signal transmission portion 511 through the waveguide device 20 disposed in the base 10. After alignment is completed, the base 10 is secured on the signal transmission portion 511, thereby fixedly securing the first connector 1 to the photonic integrated circuit 51.

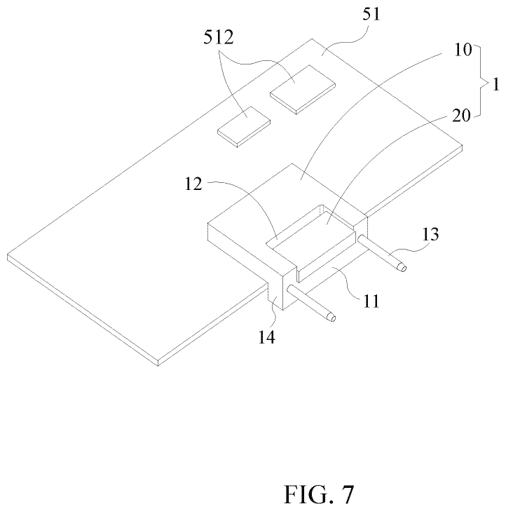

After the first connector 1 is fixed on the photonic integrated circuit 51, the optical fiber device 3 is detached from the first connector 1 as shown in FIG. 7. In this state, a portion of the waveguide device 20 directly faces the signal transmission portion 511, and the positioning elements 13 extend outward from the front end 11 in a direction substantially perpendicular to the first guide surface 24. Specifically, since the waveguide device 20 is disposed in the recessed portion 12, the surface grating coupler 28 faces the signal transmission portion 511 through the recessed portion 12. In a preferred embodiment, a projection area of the surface grating coupler 28 at least partially overlaps a projection area of the surface grating coupler 513, thereby facilitating coupling of light beams from the waveguide device 20 through the surface grating couplers 28 and 513 into the signal transmission portion 511.

During the attached state in which the optical fiber device 3 and the first connector 1 are attached to the photonic integrated circuit 51, the surface grating coupler 28 of the waveguide device 20 and the surface grating coupler 513 of the photonic integrated circuit 51 are disposed to face each other and are actively aligned. In this arrangement, light beams from the optical fiber device 3 are coupled into the waveguide device 20 and propagate along the optical waveguide paths 23. The light beams are then directed into the signal transmission portion 511 by cooperative alignment of the surface grating couplers 28 and 513 and subsequently propagate along an extension direction of the signal transmission portion 511 into the photonic integrated circuit 51.

Specifically, since the surface grating couplers 28 and 513 have a relatively larger effective coupling area compared with a coupling area between the optical fiber device 3 and the signal transmission portion 511, alignment tolerance is relatively loose, thereby improving alignment accuracy and reducing alignment difficulty during the positioning process. In a reverse direction, light beams from the photonic integrated circuit 51 passing through the signal transmission portion 511 are guided by the surface grating couplers 513 and 28 into the waveguide device 20 and are finally output to the optical fiber device 3.

In some embodiments, when multiple first connectors 1 are provided for assembly with one or more photonic integrated circuits 51, the above-described positioning and securing processes are repeated such that each first connector 1 is disposed on a corresponding photonic integrated circuit 51 or a plurality of first connectors 1 are disposed on a photonic integrated circuit 51. This arrangement reduces overall assembly time and enhances compatibility between different photonic integrated circuits 51 and first connectors 1.

In other embodiments, as shown in FIG. 10, a waveguide device 20′ further includes a second guide surface 27 formed on a side opposite the first guide surface 24. When a first connector l′ including the waveguide device 20′ and the base 10 is fixed to the photonic integrated circuit 51, the second guide surface 27 is positioned above the signal transmission portion 511. In another embodiment, a tilted micro-reflecting component (not shown for clarity) may be provided corresponding to each optical waveguide path of the waveguide device 20′ to direct at least a portion of light beams from the optical fibers 31 toward the signal transmission portion 51 without the surface grating coupler 28.

In some embodiments, referring to FIGS. 5 and 7, the optical fiber device 3 is detachably connected to the first connector 1, thereby providing a removable connection between the optical fiber device 3 and the photonic integrated circuit 51. After the optical fiber device 3 is removed, the base 10 and the waveguide device 20 remain disposed on the photonic integrated circuit 51, allowing the optical interface between the waveguide device 20 and the photonic integrated circuit 51 to be maintained independently of the optical fiber device 3. In this configuration, the surface grating coupler 513 is disposed at the signal transmission portion 511, and the surface grating coupler 28 is provided on a side of the waveguide device 20 facing the signal transmission portion 511, such that the surface grating coupler 28 and the surface grating coupler 513 are actively aligned. Through cooperative coupling of the surface grating couplers 28 and 513, light signals can be stably transmitted between the waveguide device 20 and the photonic integrated circuit 51, thereby enlarging an effective coupling area, improving alignment tolerance, enabling bidirectional optical signal transmission, and enhancing overall coupling efficiency of the optoelectronic integrated circuit. In this embodiment, each of the plurality of surface grating couplers 28 is a top-coupling grating coupler.

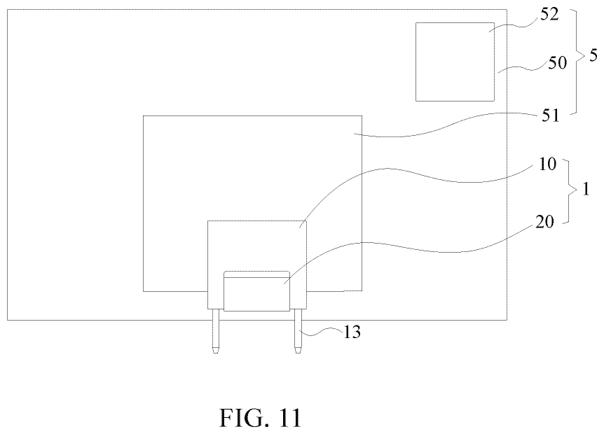

In some embodiments, referring to FIG. 11, the photonic integrated circuit 51 with the first connector 1 can then be co-packaged with a carrier board 50 carrying at least one electronic integrated circuit 52 and subjected to subsequent processes such as reflow, wire bonding, or molding, thereby forming an optoelectronic integrated circuit 5. In this configuration, the photonic integrated circuit 51 and the electronic integrated circuit 52 form an electro-optic co-package. In this way, the optical fiber device 3 is protected from exposure to the high temperatures of these processes. After co-packaging of the photonic integrated circuit 51, the electronic integrated circuit 52, and the carrier board 50 is completed, the optical fiber device 3 may be reattached to the first connector 1 to enable bidirectional transmission of light signals.

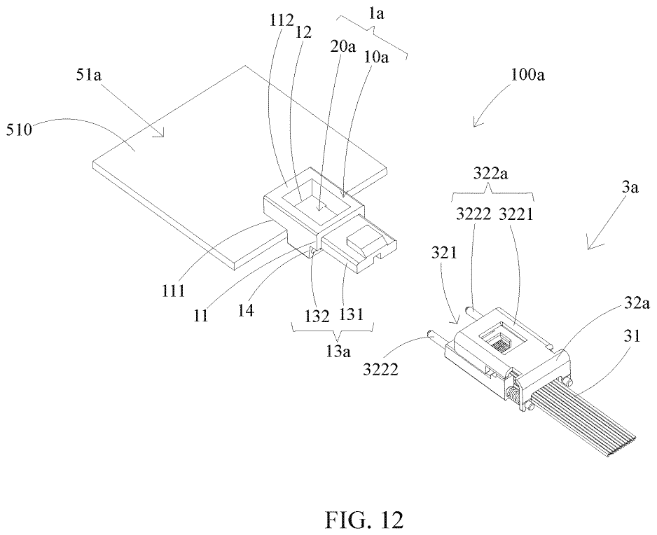

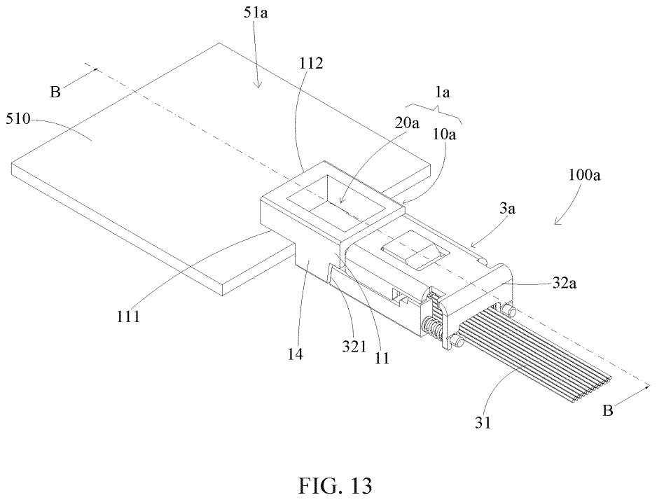

Referring to FIGS. 12 and 13, a detachable optical coupling assembly 100a according to some embodiments of the present application is provided. The detachable optical coupling assembly 100a includes a first connector 1a, a photonic integrated circuit 51a, and an optical fiber device 3a.

The first connector 1a includes a base 10a. The base 10a includes a lower surface 111, an upper surface 112, a front end 11, and a recessed portion 12. The front end 11 is disposed between corresponding edges of the lower surface 111 and the upper surface 112. The recessed portion 12 is recessed relative to the upper surface 112 and extends through the lower surface 111.

In some embodiments, the first connector 1a further includes two retaining walls 14 extending downward from the lower surface 111 and abutting against an edge of the photonic integrated circuit 51a. The two retaining walls 14 extend toward each other and cooperatively define a surrounding structure configured to receive the waveguide device 20a therein.

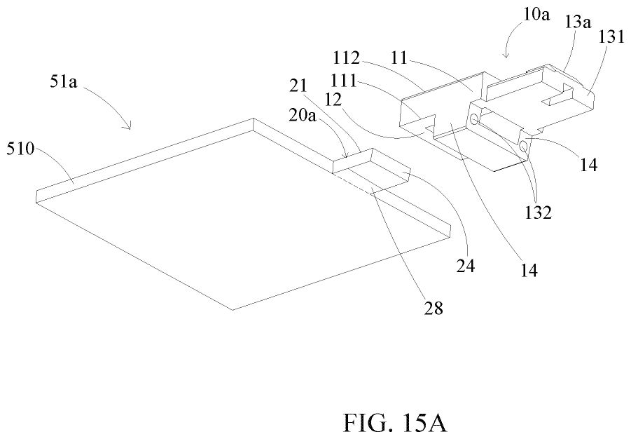

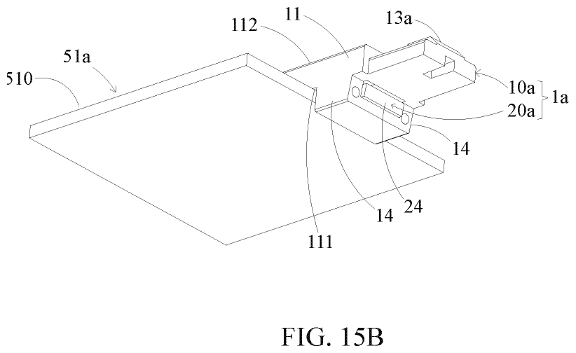

In some embodiments, as shown in FIGS. 15A and 15B, the first connector 1a further includes a plurality of positioning elements 13a. The positioning elements 13a are disposed on a side of the front end 11 facing the optical fiber device 3a. Specifically, the positioning elements 13a include at least one latching portion 131 and a plurality of positioning holes 132 spaced apart from each other and formed adjacent to the retaining walls 14.

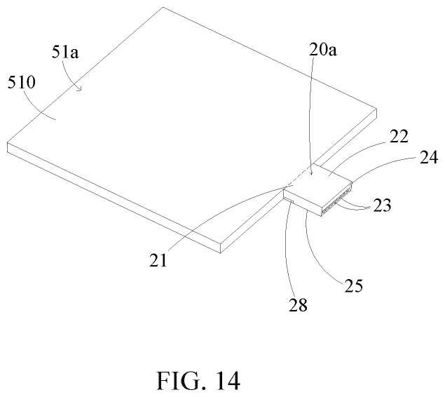

Referring to FIGS. 14, 15A and 15B, the photonic integrated circuit 51a includes a main body 510 and a waveguide device 20a. The waveguide device 20a includes a waveguide substrate 21, a first surface 22 on an upper side of the waveguide substrate 21, a second surface 25 on a lower side of the waveguide substrate 21, a first guide surface 24 adjoining the first surface 22 and the second surface 25, a plurality of optical waveguide paths 23 extending from the first guide surface 24, and a plurality of surface grating couplers 28. The waveguide substrate 21 is integrated with the main body 510. The plurality of surface grating couplers 28 are disposed at the respective ends of the plurality of optical waveguide paths 23 near the first guide surface 24. The waveguide device 20a is assembled with the base 10a by insertion into the surrounding structure defined by the retaining walls 14. When the waveguide device 20a is assembled to the base 10a, the first guide surface 24 is positioned at the front end 11 adjacent to the lower surface 111 and faces the optical fiber device 3a, while the first surface 22 of the waveguide device 20a is exposed through the recessed portion 12 of the base 10a.

In some embodiments, the main body 510 of the photonic integrated circuit 51a is silicon-based. In some embodiments, each of the plurality of surface grating couplers 28 is a side-coupling grating coupler.

In some embodiments, the photonic integrated circuit 51a includes a signal transmission portion 511 connected to the plurality of optical waveguide paths 23. A portion of the optical waveguide paths 23 of the waveguide device 20a extends toward the main body 510 and is optically coupled with the signal transmission portion 511, thereby enabling optical signal transmission between the waveguide device 20a and the photonic integrated circuit 51a.

Referring to FIGS. 12, 13 and 16, the optical fiber device 3a is configured for detachable connection to the first connector 1a and includes a plurality of optical fibers 31 and a second connector 32a with a connecting surface 321. The connecting surface 321 is configured to face the front end 11 of the base 10a. The second connector 32a includes a plurality of attaching portions 322a detachably connected to and aligned with the positioning elements 13a. In some embodiments, the attaching portions 322a include at least one latching portion 3221 and a plurality of positioning rods 3222. The latching portion 3221 is detachably engaged with the latching portion 131, and the positioning rods 3222 are spaced apart from each other and disposed adjacent to the connecting surface 321.

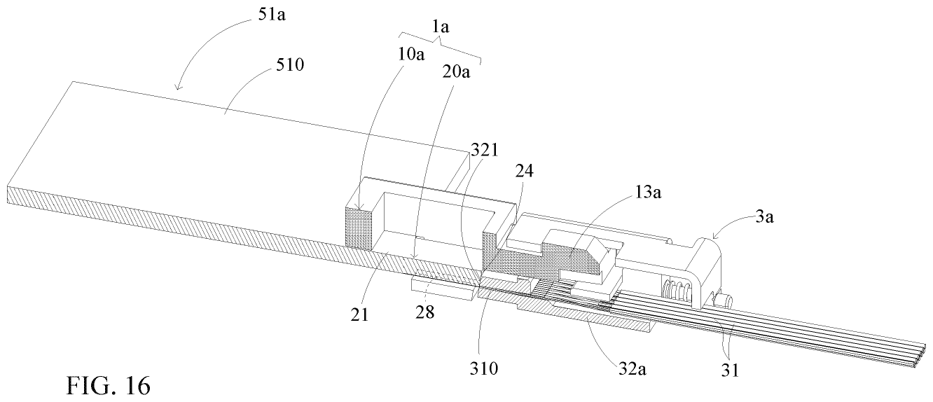

As shown in FIGS. 13 and 16, when the optical fiber device 3a is connected to the first connector 1a, the latching portions 131 and 3221 are engaged with each other, the positioning rods 3222 are respectively inserted into corresponding positioning holes 132, and the connecting surface 321 is facing the first guide surface 24. In this state, the optical fibers 31 extend to the connecting surface 321, and fiber ends 310 of the optical fibers 31 are configured to be in direct physical facing with the first guide surface 24.

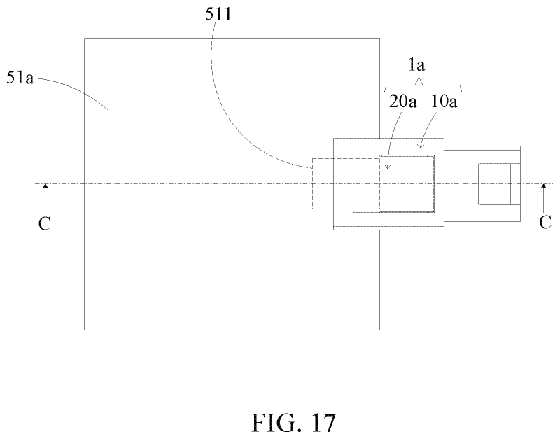

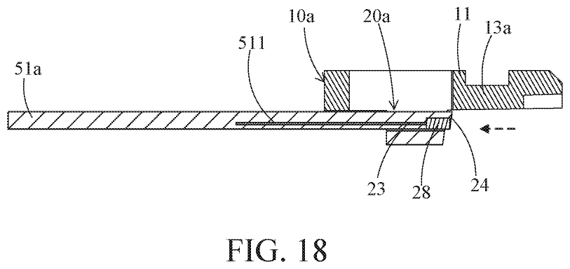

In some embodiments, referring to FIGS. 16 to 18, the first connector 1a is arranged on the photonic integrated circuit 51a, active alignment is performed only between the optical fibers 31 of the optical fiber device 3a and the waveguide device 20a by optical monitoring. In detail, the base 10a is first connected to the optical fiber device 3a before being assembled with the waveguide device 20a. At this point, the base 10a is movable relative to the waveguide device 20a. After the optical fiber device 3a and the waveguide device 20a are actively aligned with each other by optical monitoring, the base 10a is fixed to the waveguide device 20a. In this configuration, light beams entering the waveguide device 20a through the first guide surface 24 are guided along the surface grating couplers 28 to the optical waveguide paths 23 and coupled into the signal transmission portion 511 of the photonic integrated circuit 51a, such that light signals are transmitted between the optical fiber device 3a and the signal transmission portion 511 through the waveguide device 20a. In this embodiment, each of the plurality of surface grating couplers 28 is a side-coupling grating coupler.

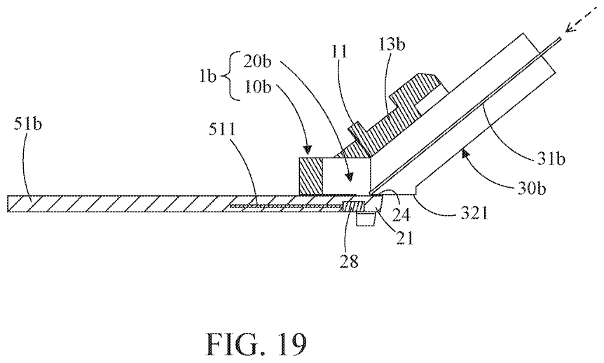

In other embodiments, referring to FIG. 19, this embodiment differs from the embodiments shown in FIGS. 12 and 13 mainly in that a plug-in direction of a first connector 1b relative to the photonic integrated circuit 51b is inclined. In this embodiment, a first guide surface 24 is an upper surface of the waveguide substrate 20b. The plurality of surface grating couplers 28 extend from the first guide surface 24 of the waveguide device 20b and optically coupled with the signal transmission portion 511. As shown in FIG. 19, a positioning element 13b of the first connector 1b is obliquely disposed on a base 10b such that the positioning element 13b tilts upward with respect to the photonic integrated circuit 51b. Accordingly, an optical fiber device 3b is pluggable to the first connector 1b in an oblique direction relative to the photonic integrated circuit 51b, so that the first guide surface 24 faces the connecting surface 321 of the optical fiber device 3b and the optical fibers 31b of the optical fiber device 3b are aligned with the surface grating couplers 28, thereby achieving a detachable optical connection between the optical fiber device 3b and the photonic integrated circuit 51b. In this embodiment, each of the plurality of surface grating couplers 28 is a top-coupling grating coupler.

According to the foregoing embodiments, the detachable optical coupling assembly provides at least the following beneficial effects.

The detachable optical coupling assembly enables the detachable connection between the optical fiber device 3 and the photonic integrated circuit 51 via the first connector 1. Accordingly, the photonic integrated circuit 51 can be co-packaged with a carrier board and subjected to subsequent packaging or assembly processes without exposing the optical fiber device 3 to high-temperature environments. As a result, potential thermal damage to the optical fiber device 3 is avoided, manufacturing yield is improved, and replacement or maintenance of the optical fiber device 3 can be performed more conveniently. In addition, in one embodiment of the disclosure, through a structural arrangement of the first connector 1, the waveguide device 20 is actively aligned with the signal transmission portion 511 of the photonic integrated circuit 51, and the optical fiber device 3/3a is actively aligned with the waveguide device 20/20a, thereby maintaining alignment accuracy during optical coupling.

Furthermore, the surface grating coupler 28 of the waveguide device 20 and the surface grating coupler 513 of the photonic integrated circuit 51 are optically coupled, such that light beams transmitted from the optical fiber device 3 are coupled into the waveguide device 20, guided toward the signal transmission portion 511, and subsequently propagated along an extension direction of the signal transmission portion 511 into the photonic integrated circuit 51. Through cooperative arrangement of the surface grating couplers 28 and 513, an effective optical coupling area is increased, alignment tolerance is enhanced, bidirectional transmission of light signals is stabilized, and overall optical coupling efficiency of an optoelectronic integrated circuit is improved.

While the present application has been described with reference to certain presently preferred embodiments, the foregoing description is intended for illustrative purposes only and should not be construed as limiting. Various modifications, alternatives, and equivalents may be made by those skilled in the art without departing from the scope of the present application.

It should be noted that while the combination of components described herein are preferred for forming the disclosed embodiments, such combinations should not be construed as limiting the scope of the present application. The disclosed components may be combined or arranged in various other ways beyond those specifically illustrated and described.

What is claimed is:

1. A detachable optical coupling assembly, comprising:
a first connector disposed on a photonic integrated circuit and comprising:
a base comprising a front end; and
a waveguide device comprising:
a waveguide substrate with a first guide surface;
a plurality of optical waveguide paths extending from the first guide surface; and
a surface grating coupler formed on the waveguide substrate, wherein the waveguide device is disposed in the base such that the first guide surface is positioned at the front end, and the surface grating coupler of the waveguide device is optically coupled to a signal transmission portion of the photonic integrated circuit; and
an optical fiber device comprising a second connector with a connecting surface and detachably connected to the first connector such that the connecting surface and the first guide surface are disposed to face each other.

2. The detachable optical coupling assembly according to claim 1, wherein the photonic integrated circuit further comprises a surface grating coupler formed within the signal transmission portion, and the surface grating coupler of the waveguide device is optically coupled to the surface grating coupler of the photonic integrated circuit.

3. The detachable optical coupling assembly according to claim 1, wherein the base further comprises a lower surface and at least one retaining wall extending downward from the lower surface, and the retaining wall abuts against an edge of the photonic integrated circuit.

4. The detachable optical coupling assembly according to claim 1, wherein the base further comprises an upper surface and a recessed portion recessed relative to the upper surface, and the waveguide device is disposed at the recessed portion.

5. The detachable optical coupling assembly according to claim 1, wherein the first connector further comprises a plurality of positioning elements disposed at the front end, and the second connector further comprises a plurality of attaching portions detachably connected to the plurality of positioning elements.

6. The detachable optical coupling assembly according to claim 1, wherein the optical fiber device further comprises a plurality of optical fibers extending to the connecting surface and arranged in correspondence with the plurality of optical waveguide paths.

7. A detachable optical coupling assembly, comprising:
a first connector comprising a base comprising a front end;
a photonic integrated circuit comprising:
a main body; and
a waveguide device comprising:
a waveguide substrate integrated with the main body and comprising a first guide surface;
a plurality of optical waveguide paths extending from the first guide surface; and
a plurality of surface grating couplers disposed at respective ends of the plurality of optical waveguide paths near the first guide surface, wherein the waveguide device is disposed in the base such that the first guide surface is positioned at the front end; and
an optical fiber device comprising:
a second connector with a connecting surface and detachably connected to the first connector such that the connecting surface and the first guide surface are disposed to face each other; and
a plurality of optical fibers extending from the connecting surface and arranged in correspondence with the plurality of surface grating couplers of the waveguide device, respectively.

8. The detachable optical coupling assembly according to claim 7, wherein the base further comprises a lower surface and at least one retaining wall extending downward from the lower surface, and the retaining wall abuts against an edge of the photonic integrated circuit.

9. The detachable optical coupling assembly according to claim 7, wherein the base further comprises an upper surface and a recessed portion recessed relative to the upper surface, and the waveguide device is disposed at the recessed portion.

10. The detachable optical coupling assembly according to claim 7, wherein the first connector further comprises a plurality of positioning elements disposed at the front end, and the second connector further comprises a plurality of attaching portions detachably connected to the plurality of positioning elements.

11. The detachable optical coupling assembly according to claim 7, wherein the photonic integrated circuit further comprises a signal transmission portion connected to the plurality of optical waveguide paths.

12. The detachable optical coupling assembly according to claim 7, wherein each of the plurality of surface grating couplers is a side-coupling grating coupler.

13. The detachable optical coupling assembly according to claim 7, wherein the first guide surface is an upper surface of the waveguide substrate, and an extension direction of the plurality of optical fibers disposed near the connecting surface forms an acute angle with the upper surface.

14. The detachable optical coupling assembly according to claim 13, wherein each of the plurality of surface grating couplers is a side-coupling grating coupler.
